(19) United States
(12) Patent Application Publication
(10) Pub. No.: US 2003/0069065 A1
(43) Pub. Date: Apr. 10, 2003

(54) Slot game machine and pachinko machine equipped with slot game machine

(76) Inventor: Kouzou Natsuyama, Hamamatsu-shi (JP)

Correspondence Address: MURAMATSU & ASSOCIATES, Suite 225, 7700 Irvine Center Drive, Irvine, CA, 92618, US

(21) Appl. No.: 09/974,208

(22) Filed: Oct. 10, 2001

(51) Int. Cl. A63F 13/00

(52) U.S. Cl. 463/20; 273/138.3; 273/139

(57) ABSTRACT

There is disclosed a slot game machine in which plural kinds of numbers are arbitrarily appeared in each of three frame windows which are arranged in juxtaposed relation and during the time the numbers in each frame window are being changed, one number out of the changing plural numbers is stopped in each frame window by corresponding stop means, wherein one of the three frame windows is designed as a reference frame window and when the correlation among the numbers stopped in the respective frame windows becomes such that the number stopped in the reference frame window is larger than the number stopped in one of the remaining two frame windows but smaller than the number stopped in the other remaining frame window, a win signal is output. A pachinko machine equipped with a slot machine is also disclosed.

### FIELD OF THE INVENTION

This invention relates to an improvement of a slot game machine and a pachinko machine equipped with a slot game machine.

### RELATED ART

Slot game machines of this type have heretofore been known, in which plural kinds of numbers are arbitrarily appeared in each of three frame windows which are laterally arranged in juxtaposed relation. During the time the numbers in each frame window are being changed, one number out of the changing plural numbers is stopped in each frame window by corresponding stop means. When the numbers stopped in the three frame windows are all matched, a win signal is output to pay out win coins in case the machine is a slot game machine or to pay out win pachinko balls in case the machine is a pachinko machine equipped with a slot game machine.

### SHORTCOMINGS OF RELATED ART

The conventional slot game machines and conventional pachinko machines equipped with a slot game machine can, in face, offer enjoyment as a game machine to players. The inventor of the present invention has made extensive search and development in order to make an improved slot game machine and an improved pachinko machine equipped with a slot game machine with which players can really enjoy the play with fresh excitement and amusement. As a result, the present invention has been accomplished.

### OBJECT OF THE INVENTION

It is, therefore, an object of the present invention to provide a slot game machine and a pachinko machine equipped with a slot game machine which can offer new enjoyment and enhanced amusement.

### CONSTRUCTION OF THE INVENTION

From one aspect of the present invention, there is provided, in order to achieve the above object, a slot game machine in which plural kinds of numbers are arbitrarily appeared in each of three frame windows which are arranged in juxtaposed relation and during the time the numbers in each frame window are being changed, one number out of the changing plural numbers is stopped in each frame window by corresponding stop means, wherein one of the three frame windows is designed as a reference frame window and when the correlation among the numbers stopped in the respective frame windows becomes such that the number stopped in the reference frame window is larger than the number stopped in one of the remaining two frame windows but smaller than the number stopped in the other remaining frame window, a win signal is output.

In the above slot game machine, the changing numbers in the reference frame window may be stopped last.

From another aspect of the present invention, there is also provided, in order to achieve the above object, a pachinko machine equipped with a slot game machine in which plural kinds of numbers are arbitrarily appeared in each of three frame windows which are arranged in juxtaposed relation and with a condition of a particular win pachinko ball, the numbers in the three frame windows are changed by appropriate means and the numbers being changed in each of the three frame windows are stopped by corresponding stop means such that one number out of the changing plural numbers in each of the three frame windows, wherein one of the three frame windows is designed as a reference frame window and when the correlation among the numbers stopped in the respective frame windows becomes such that the number stopped in the reference frame window is larger than the number stopped in one of the remaining two frame windows but smaller than the number stopped in the other remaining frame window, a win signal is output.

In the above pachinko machine equipped with a slot machine, the changing numbers in the reference frame window may be stopped last.

### FUNCTION AND EFFECT OF THE INVENTION

Since a slot game machine according to the present invention has the above-mentioned construction, a win signal can be output with a combination of numbers which can never be found in any combination of win numbers of the conventional slot game machines.

Therefore, with the use of the slot game machine according to the present invention, entirely new entertainment and amusement can be enjoyed.

In case the changing numbers in the reference frame window are designed to be stopped last, the number to be stopped in the reference frame window must satisfy the two conditions mentioned above and therefore, excitement is skyrocketed until the particular number is stopped.

Moreover, since a pachinko machine equipped with a slot game machine according to the present invention has the above-mentioned construction, a win signal can be output with a combination of numbers which can never be found in any combination of win numbers of the conventional pachinko machines equipped with a slot game machine.

### BRIEF DESCRIPTION OF THE DRAWINGS

FIG. 1 is an explanatory view of one embodiment of a slot game machine according to the present invention.

### DESCRIPTION OF THE EMBODIMENT

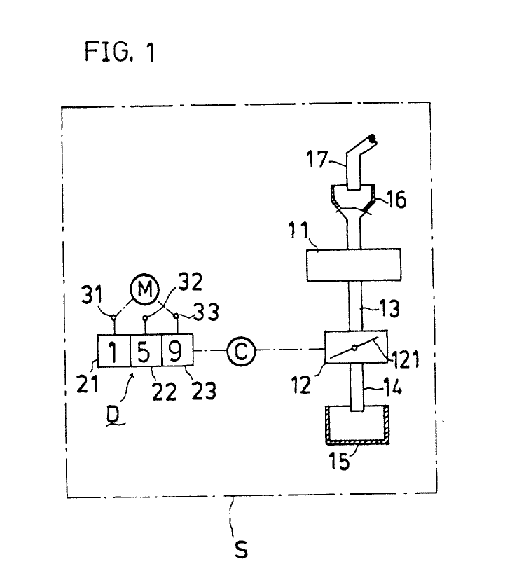

The present invention will now be described with reference to FIG. 1 which is an explanatory view of one embodiment of a slot game machine.

In FIG. 1, Reference symbol S denotes a slot game machine and 11 denotes a coil stock box of the slot game machine S. This coil stock box 11 stocks therein a predetermined number of coils (hereinafter referred to as the “win coins”) which are paid out for every one win. Reference symbol 12 denotes a door unit. This door unit 12 is disposed under the coin stock box 11. The door unit 12 is connected to the coin stock box 11 through a first duct 13. Because of this arrangement, the win coins reach an upper part of the door unit 12 through the first duct 13. Reference symbol 14 denotes a second duct. This second duct 14 is connected to a lower side of the door unit 12. The win coins are discharged into a coin tray 15, which is installed at a lower part of the slot game machine S, through the second duct 14.

Reference symbol D denotes a slot display unit in the above slot game machine. Reference symbols 21, 22 and 23 denote numeric frame windows of the slot display unit D. There are three numeric frame windows 21, 22, 23. Although those three numeric frame windows 21, 22, 23 are horizontally (i.e., laterally arranged in juxtaposed relation) in this embodiment, they may be arranged diagonally. In this embodiment, the numeric frame window 22 located at the center is designed as a reference frame window. However, any one of the numeric frame windows 21, 22, 23 may be designed as a reference frame window. The numbers appeared within the numeric frame windows 21, 22, 23 are changeable within a range of 0 to 9 by revolving of a drum or endless belt which is actuated by appropriate driving means such as, for example, a stepping motor as a driving source for the conventional slot game machine, or by means of a digital display. In FIG. 1, a number “1” is displayed in the numeric frame window 21, “5”, in the reference numeric frame window 22, and “9”, in the numeric frame window 23, respectively. Reference symbols 31, 32, 33 denote control levers (which correspond to “stop means” of the present invention). Those control levers 31, 32, 33 are installed in such a manner as to correspond to the numeric frame windows 21, 22 and 23, respectively. The player controls those control levers 21, 22, 23 independently. By doing so, the numbers changing in the respective numeric frame windows 21, 22, 23 can be stopped so that one specific number is stopped in each numeric frame window. It is also possible that by controlling the main lever M, the above-mentioned three control levers 31, 31, 33 can be stropped one after another, as indicated by an imaginary line. In this case, it can be designed such that the control lever 32 for the reference numeric frame window 22 located at the middle is stopped last. The first control lever 31 is for stopping the numeric frame window 21, the second control lever 32 is for stopping the numeric frame window 22 and the third control lever 33 is for stopping the numeric frame window 23. It is also an interesting alternative that by appropriate driving means such as, for example, a stepping motor as a driving source for the conventional slot game machine, the changing numbers in each numeric frame window are stopped to show only one number each after passage of a predetermined time from the time the numbers start changing.

When the correlation among the numbers stopped in the respective numeric frame windows 21, 22, 23 becomes such that the number in the reference numeric frame window 22 located at the middle is larger than the number in the numeric frame window 21 on the left side but smaller than the number in the numeric frame window 23 on the right side (see the state of FIG. 1), or such that the number in the reference numeric frame window 22 located at the middle is smaller than the number in the numeric frame window 21 on the left side but larger than the number in the numeric frame window 23 on the right side (see the state of FIG. 1), a win signal is electrically transmitted to a control unit C by appropriate means such as, for example, detection means for detecting figures and numbers used in the conventional slot game machine. Upon receipt of the signal, the control unit C actuates driving means (solenoid or the like) for the door unit 12 so that the door unit 12 is opened. Then, the win coins stocked in the coin stock box 11 are discharged into the coin tray 15 through the second duct 14. When a predetermined time is passed after the coins are discharged, the driving means (solenoid or the like) for the door unit 12 is actuated through the control unit C to close the door unit 12. On the other hand, the corresponding number of coins to the win coins just paid out are supplemented to the coin stock box 11 through the main duct 16.

### EXAMPLE 1

Presume that a number “2” stops in the numeric frame window 21 as a first number (number to be stopped first) and a number “8” stops in the numeric frame window 23 as a second number (number to be stopped second). In this condition, if a number “3”, “4”, “5”, “61” or “7” stops in the reference numeric frame window 22 as a last number (number to be stopped last), a win signal is output. If a number “1”, “2”, “8” or “9” stops in the reference numeric frame window 22 as a last number, no win signal is output.

Likewise, presume that a number “8” stops in the numeric frame window 21 as a first number and a number “4” stops in the numeric frame window 23 as a second number. In this condition, if a number “3”, “4”, “5”, “6” or “7” stops in the reference numeric frame window 22 as a last number, a win signal is also output. If a number “1”, “2”, “8” or “9” stops in the reference numeric frame window 22 as a last number, no win signal is output.

### EXAMPLE 2

Presume that a number “4” stops in the numeric frame window 21 as a first number and a number “6” stops in the numeric frame window 23 as a second number. In this condition, only if a number “5” stops in the reference numeric frame window 22 as a last number, a win signal is output. However, even if one of the remaining numbers “1”, “2”, “3”, “4”, “6”, “7”, “8” and “9” stops in the reference numeric frame window 22 as a last number, no win signal is output.

Likewise, presume that a number “6” stops in the numeric frame window 21 as a first number and a number “4” stops in the numeric frame window 23 as a second number. In this condition, only if a number “5”stops in the reference numeric frame window 22 as a last number, a win signal is also output. If a number “1”, “2”, “3”, “4”, “6”, “7”, “8” or “9” stops in the reference numeric frame window 22 as a last number, no win signal is output.

### EXAMPLE 3

Presume that a number “4” stops in the numeric frame window 21 as a first number and a number “7” stops in the numeric frame window 23 as a second number. In this condition, only if a number “5” or “6” stops in the reference numeric frame window 22 as a last number, a win signal is output However, even if one of the remaining numbers “1”, “2”, “3”, “4” “7”, “8” and “9” stops in the reference numeric frame window 22 as a last number, no win signal is output.

Likewise, presume that a number “7” stops in the numeric frame window 21 as a first number and a number “4” stops in the numeric frame window 23 as a second number. In this condition, only if a number “5” or “6” stops in the reference numeric frame window 22 as a last number, a win signal is also output. If a number “1”, “2”, “3”, “4”, “7”, “8” or “9” stops in the reference numeric frame window 22 as a last number, no win signal is output.

### EXAMPLE 4

Presume that a number “5” stops in the numeric frame window 21 as a first number and another number “5” stops in the numeric frame window 23 as a second number. In this condition, even if any number stops in the reference numeric frame window 22 as a last number, no win signal is output. In other words, no win signal is output at all in that condition. Only when there is a difference (integer) between the number which stops in the first numeric frame window 21 as a first number and a number which stops in the numeric frame window 23 as a second number, a win signal is output.

Although in the above examples, the numeric frame window 21 is set to a numeric frame window in which a first number (number to be stopped first) stops, the numeric frame window 23 is set to a numeric frame window in which a second number (number to be stopped second) stops and the numeric frame window 22 is set to a numeric frame window in which a reference number (number to be stopped last) stops, the roles of those numeric frame windows 21, 22 and 23 may be interchanged in accordance with necessity.

The slot display unit D may be applied to a pachinko machine. In this case, the slot display unit D is mounted on the front nailed panel of the pachinko machine. With a condition of a particular win ball (for example, a pachinko ball is received into a win hole formed in the front nailed panel of the pachinko machine), the drum or endless belt is actuated by the appropriate driving means such as, for example, a stepping motor as a driving source for the conventional slot game machine. In this case, a predetermined number of win balls instead of win coins are paid out. In this way, the present invention can be incorporated in a pachinko machine equipped with a slot game machine.

In this embodiment, the numeric frame window located at the center is designed as a reference numeric frame window. However, depending on the construction of pachinko machines, the numeric frame window located on the right side or on the left side (in FIG. 1) may be designed as a reference numeric frame window.

Moreover, the arrangement of the numeric frame windows are not limited to the horizontal arrangement as illustrated. They may, of course, be arranged diagonally in a linear form.

Obviously, many modifications and variations of the present invention are possible in light of the above teachings. It is, therefore, to be understood that within the scope of the appended claims, the invention may be practiced otherwise than as specifically described.

What is claimed is:

1. A slot game machine in which plural kinds of numbers are arbitrarily appeared in each of three frame windows which are arranged in juxtaposed relation and during the time the numbers in each frame window are being changed, one number out of the changing plural numbers is stopped in each frame window by corresponding stop means, wherein one of said three frame windows is designed as a reference frame window and when the correlation among the numbers stopped in the respective frame windows becomes such that the number stopped in said reference frame window is larger than the number stopped in one of the remaining two frame windows but smaller than the number stopped in the other remaining frame window, a win signal is output.

2. A slot game machine according to claim 1, wherein the changing numbers in said reference frame window are stopped last.

3. A pachinko machine equipped with a slot game machine in which plural kinds of numbers are arbitrarily appeared in each of three frame windows which are arranged in juxtaposed relation and with a condition of a particular win pachinko ball, the numbers in said three frame windows are changed by appropriate means and the numbers being changed in each of said three frame windows are stopped by corresponding stop means such that one number out of the changing plural numbers in each of said three frame windows, wherein one of said three frame windows is designed as a reference frame window and when the correlation among the numbers stopped in the respective frame windows becomes such that the number stopped in said reference frame window is larger than the number stopped in one of the remaining two frame windows but smaller than the number stopped in the other remaining frame window, a win signal is output.

4. A pachinko machine equipped with a slot game machine according to claim 3, wherein the changing numbers in said reference frame window are stopped last.
